(19) United States
(12) Patent Application Publication
(10) Pub. No.: US 2006/0095961 A1
(43) Pub. Date: May 4, 2006

(54) Auto-triage of potentially vulnerable network machines

(76) Inventors: Priya Govindarajan, Hillsboro, OR (US); Ravi Sahita, Beaverton, OR (US); Dylan C. Larson, Beaverton, OR (US); David M. Durham, Hillsboro, OR (US); Raj Yavatkar, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/976,397

(22) Filed: Oct. 29, 2004

(51) Int. Cl. G06F 15/16

(52) U.S. Cl. 726/15

(57) ABSTRACT

Method, apparatus, and system for isolating potentially vulnerable nodes of a network. In one embodiment a network is partitioned into subnets of varying levels of security. A client device may be assigned a network access assignment through one of the subnets based on a level of vulnerability assessed for the client device. The level of vulnerability may be determined based on compliance of the client device with available upgrades and/or patches.

### FIELD

Embodiments of the invention relate to network security and specifically to assigning network access to a network node according to a level of security of the network node.

### BACKGROUND

A large number of vulnerabilities in software and machines are detected every day and these vulnerabilities pose a huge threat to an enterprise. There is traditionally a time lag between the detection of vulnerabilities and availability of fixes. Sometimes, even when a fix is available, administrators are not able to deploy the fix immediately due to time constraints or lack of adequate testing of the fix on their specific systems. It is during this time lag that most attacks are successful. Currently, anomalous and attack traffic flows throughout traditional networks affecting any vulnerable machines they can discover. The administrator may employ an intrusion detection system (IDS) in a De-Militarized Zone (DMZ) of their network (e.g., an area of restricted access to buffer a network from anomalous traffic) to look at traffic only as it enters and leaves the network. Mobile internal nodes may also leave the network and come back into the network in an infected state. Internal nodes may not be patched with the latest updates in time, which may cause the machine to both be vulnerable when outside the network, and cause potential harm when the machine returns back inside. Guest mobile nodes visiting networks are generally not under the administrative control of the visited networks administrators who traditionally have control over only their network infrastructure devices. All of the above scenarios pose considerable risks to the corporate environment that cause harm not addressed by current solutions, especially the threat of undetected internal anomalous traffic.

### BRIEF DESCRIPTION OF THE DRAWINGS

The description of embodiments of the invention includes various illustrations by way of example, and not by way of limitation in the figures and accompanying drawings.

FIG. 1 represents an embodiment of a network with a secure subnetwork partition.

FIG. 2 represents an embodiment of a client having a manageability engine and network interface filter.

FIG. 3 represents an embodiment of network management elements in a network.

FIG. 4 represents an embodiment of a client having a security agent and an out-of-band interface to a network management node.

FIG. 5 represents an embodiment of a flow diagram of a network client accessing a securely segmented network.

FIG. 6 represents an embodiment of a flow diagram of a network management node assigning network access based on security of a node.

FIG. 7 represents an embodiment of a flow diagram of a network management node assigning network access based on security compliance.

### DETAILED DESCRIPTION

A secure subnet partition and associated control functions may provide a mechanism to efficiently detect and quarantine vulnerable systems in a network. For example, some or all network traffic of a potentially vulnerable system may be diverted through a secure zone. In a virtual network sense, the system may be considered to be placed in a quarantine area. A quarantine area may be a virtual network partition isolated from other nodes in the network. In one embodiment the network partition, or subnet, may be isolated in that other nodes in the network may not have direct access to the subnet and/or traffic in the subnet.

Isolation of vulnerable or possibly vulnerable systems/machines/nodes enables an administrator to closely observe vulnerable systems in the quarantine area and deploy patches/updates/upgrades at the convenience of the administrator. The administration associated with diverting the machine and/or performing the updates may be facilitated with an out-of-band (OOB) communication mechanism. The entire process may occur via mechanisms transparent to the user and/or to a platform of the user's system. Thus, the users of the machines may be unaware of the diversion and be allowed normal access to resources. The administrator may thus more closely observe traffic from these potentially vulnerable machines and concentrate intrusion detection efforts in an isolated network. This may enable the administrator to detect and contain attacks more effectively.

In one embodiment anomalous and attack traffic may be identified through host/platform intrusion detection/tolerant systems. Identified anomalous traffic may be routed to an Intrusion Detection System (IDS) in an isolated subnet to analyze the traffic in that subnet. Traffic in the subnet may be prevented from reaching other machines in the network. In one embodiment traffic may be routed to machines in the network that are not within the isolated subnet, under close observation of the traffic at the quarantine subnet. Traffic may thus be filtered from the quarantine area to other nodes in the network. In one embodiment mobile internal node that leaves the network and comes back into the network may have its traffic automatically redirected through the quarantine area until a platform of the node undergoes a check for infection stage and/or a Minimum Security Specification (MSS) verification. Information related to detecting that a node leaves the network may be gather as discussed herein.

Traffic associated with/generated by a machine considered a low risk of vulnerability may be considered to be directed or “corralled” to an “OK corral,” referring to a VLAN identified by a VLAN identifier (ID) the machine may be assigned to use for network access. Traffic associated with/generated by a machine considered to be a higher risk of vulnerability may be considered to be directed or corralled to a “NOT OK corral,” referring to a VLAN identified by a VLAN ID of a quarantine area. In one embodiment machines with unverified/non-immunized platforms are initially assigned to a NOT-OK Corral VLAN. Likewise, in one embodiment mobile machines re-connecting to the network after connecting to some outside network are reset to not-verified, allowing the machine to be tested for vulnerability and verified prior to allowing normal access to the machine. This may be accomplished with an out-of-band platform management service to set some properties on a network interface, or network interface card (NIC) of the machine. An OOB platform management service and/or OOB communication mechanism/channel may refer to the use of a communication channel/signaling mechanism that may be transparent and/or agnostic to an operating system (OS) and/or application running on a platform of the machine. Thus, the communication may be inaccessible to elements of the machine that are traditionally susceptible to compromise by malware and/or attack/hacking (e.g., OS, application, basic input/output system (BIOS), software firewall, etc.) The OOB management service may include hardware on the platform with management software controlled by a network administrator.

In one embodiment a machine in the network includes one or more of the following capabilities: be programmable to store, for example for authentication, a home network address range (e.g., an Internet Protocol (IP) Range) and/or a switch port MAC address; be able to filter and monitor DHCP (Dynamic Host Configuration Protocol) traffic state to extract leased IP address; be able to save state in a case where an IP address assignment received is not in home range and/or authentication with a stored/preconfigured/default/expected switch port did not complete successfully (e.g., authentication may be completed with another switch port). In one embodiment OS dependent functionality may also be used. For example, installing new software and/or modifying already installed software may cause or result in an enterprise owned platform setting a flag. A flag may be one or a series of bits, digital and/or binary values, etc., which may be understood by a querying device to indicate a state or condition, or other information. For example, the flag set when software is installed and/or modified may indicate a potential taint in the machine. A system with a platform having a taint flag may be placed in triage mode, for example, until verification of the system integrity is completed.

In one embodiment partitioning the network and corralling network nodes may be accomplished through the use of VLAN tags/IDs. For example, one VLAN tag may represent the OK corral, and another VLAN tag may represent the NOT-OK corral. Additional VLAN tags may be used to represent differing levels of security within the OK corral and NOT-OK corral. In this manner multiple VLAN tags may be used to provide multiple levels of access security. An entire network (e.g., a campus environment, an enterprise network) may be virtually partitioned into VLANs, and each node within the network assigned to one of the VLANs. A guest node may be present in the network, which may not have knowledge of the VLAN tags/IDs employed by the network. In one embodiment a single port switched VLAN is used in the network, and a node using no VLAN tags (e.g., a guest) is treated as the most vulnerable.

A guest node (i.e., a platform not owned by the enterprise) may attempt to enter the network. Because the guest node is not owned by the enterprise, it may not have knowledge of what VLAN tags to use. Such a node may be treated as most vulnerable, and so be allowed network access only through triage subnet. Such a node may also not have some of the security functionality employed by nodes owned by the enterprise, for example, platform configuration monitoring. One functionality the node may not support is the above-mentioned setting a taint flag; thus, in one embodiment a system with a non-enterprise owned platform may always be placed in the NOT-OK corral, unless a mechanism may exist for enterprise management to monitor and/or verify the platform software configuration.

A rogue/attacker node may potentially sniff and get the VLAN tags in use by the network. The dirty rogue may attempt to run attack traffic with various sniffed VLAN tags to discover if one is not being monitored, which could then be exploited to infiltrate the network with attack traffic. In one embodiment such an attack may be anticipated, and mechanisms may be put in place to infer such malicious activity and/or automatically remedy the activity and/or indicate malicious activity to an administrator. For example, the use of invalid VLAN tags on a single port (or VLAN scanning) may trigger an alert to a management station, which may temporarily disable the port. In another approach, a network administrator may use different OK and NOT-OK VLAN tags for each or multiple subnets, with correct mapping for traffic crossing the subnets across the trunks. The network administrator may provide correct VLAN mappings from a central console for switches. Because the mapping may be performed at the switches, the attacker would potentially have to sniff traffic on all subnets to cover the entire network.

Mobile stations/nodes may also present another potential network vulnerability. Being mobile, a user of the station may remove the node from the network and access another network of unknown and/or distrusted security (e.g., at an airport, at a coffee shop/food establishment, at a sales location, etc.). In one embodiment the potential vulnerability of mobile stations may be addressed by having the platform save the state of its configuration when the mobile node leaves the network. Upon return to the network, the platform may analyze system characteristics/configuration and send the information to a vulnerability database cross check component on the network (e.g., as a separate node, as part of a management node, etc.). The mobile node may automatically use and/or be assigned a VLAN ID that maps to a NOT-OK corral VLAN until it receives a security indication (e.g., an MSS (minimum security specification), a security policy compliance confirmation, etc.) from the administrator. Once the administrator determines that the node meets the MSS or other policy, it may begin accessing the network using the OK corral VLAN ID. A desktop node may similarly send system specifications periodically to the vulnerability database checker to determine if there is an exploitable vulnerability in any of the applications on the node. If it is determined to be potentially vulnerable, the node may be configured to use the NOT-OK corral VLAN ID for all its traffic. The node may be changed back to begin sending traffic through the OK corral VLAN ID once the node conforms to a security specification (e.g., through installing a patch, running an update, etc.).

Various references herein to an “embodiment” are to be understood as describing a particular feature, structure, or characteristic included in at least one embodiment of the invention. Thus, the appearance of phrases such as “in one embodiment,” or “in alternate an embodiment” may describe various embodiments of the invention, and may not necessarily all refer to the same embodiment.

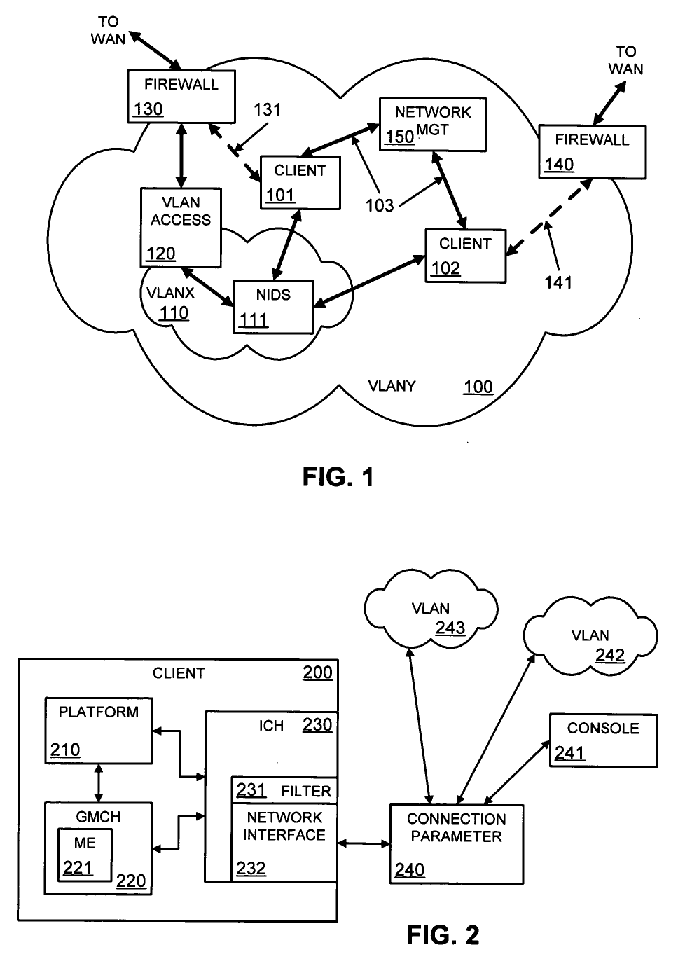

FIG. 1 represents an embodiment of a network with a secure subnetwork (subnet) partition. Virtual local area network Y (VLANY) 100 (generically “the network”) may represents a network or a network partition. VLANY 100 may be, for example, an enterprise network. Because VLANY 100 is a virtual LAN, the nodes in VLANY 100 may or may not be located physically in the same place. In one embodiment VLANY 100 represents all or part of a physical network that is defined at a management level to be a virtual network. This may be accomplished, for example, by having each node of VLANY 100 use a VLAN tag/ID. VLAN tagging of nodes within the network may provide network administration/management with one or more mechanisms for securing the network.

In one embodiment the network is subdivided/segmented/partitioned into multiple separate virtual segments/subnets. For example, a network administrator can partition the network into different VLANs via network infrastructure devices/tools that support this capability. For purposes of illustration, and not by way of limitation, FIG. 1 illustrates two partitions, VLANY 100 and VLANX 110. More partitions may be used. For example, there may be a VLAN that handles critical vulnerabilities, one that handles moderate risk vulnerabilities, one for low risk vulnerabilities, and a main VLAN that is considered free of vulnerabilities. Intrusion detection systems (IDSs) may be deployed in different sensitivity VLANs to observer traffic and be configured to look for specific anomalous traffic. In one embodiment a node in the network is tagged with a VLAN ID identifying VLANY 100 or VLANX 110. In one embodiment all network nodes except guest nodes are associated with either VLANY 100 or VLANX 110 through a VLAN ID/tag.

In one embodiment VLANY 100 represents a VLAN of systems considered to be safe, or free from vulnerabilities. Integrity of the systems may provide for network management to exercise less stringent monitoring of traffic from these systems. In one embodiment VLANX 110 represents a VLAN of systems considered to be potential vulnerability threats. Thus, traffic through VLANX 110 may be closely monitored, as contrasted to, or in comparison to, traffic associated with nodes of VLANY 100. For example, VLANX 110 may include one or more components to execute intrusion detection. Network intrusion detection system (NIDS) 111 represents the one or more components for detecting intrusion/protecting against intrusion. NIDS 111 may monitor traffic packets, identify users and/or targets, and signal breaches and/or potential breaches.

VLANX 110 may have a VLAN access point 120, which may represent a secure gateway, switch, router, and/or server, and may include a firewall. VLAN access 120 may provide additional security to prevent attack against or from a node in the network. Furthermore, VLAN access 120 may provide a mechanism for isolating VLANX 110 from VLANY 100. For example, traffic through (transmit and/or receive) VLAN access 120 may be restricted to prevent attack traffic from reaching nodes of VLANY 100. Nodes in VLANY 100 may also be prevented direct and/or indirect access to VLANX 110 and nodes within it. VLANX 100 may be considered a remedial subnet, a NOT-OK corral, a restricted area, etc.

Clients 101 and 102 may represent a variety of electronic systems, devices, machines, or apparatuses. For example, clients 101 and 102 may include a personal computer (desktop, laptop, palmtop), a server, a handheld computing device, personal digital assistant (PDA), wireless computing device, cellular phone, game console, set-top box, etc. The access of clients 101 and 102 may include wired and/or wireless connections with a routing/switching/access point on the network. Clients 101 and 102 may be a terminating or user devices of a network. Clients 101 and 102, as well as other clients that may be part of the network, may include a host platform, described in more detail below. The platform may include hardware and/or software to perform operations on the clients, e.g., to “run” clients 101 and 102. The platform may be monitored/queried to determine a state of the platform and/or a configuration of the platform to determine a level of vulnerability of the machine.

At a platform level of clients 101 and 102, the systems may include the ability to detect system characteristics like device information, operating system version, applied patches, details of applications installed on the machine, etc. One example includes using hooks into the OS to obtain this information. Alternatively, or in addition, a BIOS may be accessed/queried for information. This information may be stored in a location that is not directly under the control of the operating system and/or is in a secure portion of the system that is accessible only to authorized and authenticated entities. Isolation of the information may prevent a virus or worm from compromising the system and changing the secure data stored in this location. Periodically, this saved information may be transmitted to a known location in a secure manner, as discussed below. Also, in a mobile node the system information may be recalculated and transmitted when the node leaves and/or rejoins the network.

For purposes of example, client 101 will be described as a mobile (e.g., portable, a laptop, configurable to be easily removable from the network) node, and client 102 will represent a stationary (e.g., not easily removable, a desktop) node. Clients 101 and 102 may be nodes that will interact (e.g., transmit/receive/exchange traffic) over the network and/or with devices outside the network with one or more of various supported communication protocols. In one embodiment clients 101 and 102 include platforms owned by the enterprise associated with the network. The network may include a network policy, which is applied to each node desiring access to its resources. The network policy may include specifications for access, restrictions and/or limitations on use of the network, etc.

In one embodiment client 101 is introduced into the network. For example, client 101 may be connected for a first time, or client 101 may have left the network and later returned to it. As client 101 attempts to connect to the network, it may at first be considered a potentially vulnerable system because its platform is unverified. In the case of a new network entity, a state of the platform may be determined and the information sent to network management 150. In one embodiment client 101 employs a VLAN ID associated with VLANX 110. This may be through default configuration, automatic selection, assignment on startup (e.g., from network management 150), or any other mechanism. In the case of client 101 leaving the network and then returning, the state of the machine may be stored by the platform, and at connection (e.g., during authentication) the configuration of the machine may be tested. If the machine has fallen out of compliance, or in one embodiment, the mere fact that the machine accessed an unknown and/or non-secure network may cause the machine to be flagged for access through the remedial subnet. Access of client 101 of the network through the remedial subnet may continue in either case until the security of a platform of client 101 can be determined. For example, network management 150 may compare the state/configuration of client 101 against a database and/or a network policy. Client 101 may be determined to match the policy (be in compliance) or may be determined to require one or more components to come into compliance. Compliance may involve installing upgrades, patches, etc., on client 101. Thus, either as a new client, or as a returning client, client 101 may then be granted access to VLANY 100.

Another approach to follow when client 101 rejoins the network may be to simply not allow the system to access the network until a basic system validation check is completed, rather than redirecting its traffic over a separate VLAN. For example, the platform (e.g., via a microcontroller on a NIC) could be responsible for keeping track when the host leaves and reenters a network. Upon return, only management traffic may be allowed and the microcontroller may relay to management what has changed. The microcontroller may detect system configuration changes by maintaining the time when the system information was last queried and determining what was added or removed since then. If the changes meet the specifications for the network, the system may be allowed onto the network.

In one embodiment client 102 represents a stationary client. While the condition that client 102 accessed another network may be unusual or unlikely, other factors may cause client 102 to be considered a potentially vulnerable node. In the case of either client 101 or client 102, if a new security patch has been announced, if the client does not have the latest security patch, the client could be considered potentially vulnerable. Thus, client 102 and client 101 may periodically query and/or be queried by network management 150 to determine compliance with a security policy. This may occur over a communication link 103. In one embodiment link 103 is an out-of-band (OOB) communication link. An OOB link may be inaccessible to the OS and/or other applications on the clients, and thus be less susceptible to compromise. The clients and network management 150 may engage in secure communication over links 103 to exchange state information, transfer management data and/or commands, etc.

In one embodiment all machines that are part of the network include a link 103, a separate OOB management interface. This interface can be a component that resides on an Ethernet controller or a component that is on the chipset of the system. Using this interface and certain capabilities on an Ethernet controller and/or network interface access circuit (e.g., a NIC (network interface card)), the administrator can configure the machine to send all its traffic to a particular VLAN. For example, if client 101 is known to have a critical vulnerability, it can be configured via this OOB interface to send its traffic through the VLAN responsible to check for critical vulnerabilities. The security devices on this VLAN can then perform extensive checks on the traffic flowing within and out of that particular network. The network administrator can closely watch and eliminate attacks. Similar VLAN support may be used to make sure that traffic from visiting guest nodes that are not under administrative control of the network goes through extensive checks and network security devices of the visited network.

In one embodiment network management 150 represents one or more management elements on the network. This may include as one element, or as part of an element, a vulnerability database cross indexer/security database/policy decision point. A network administrator may maintain a database of known vulnerabilities of different applications and operating systems. For example, this information is typically available on various websites, and can be generally easily obtained. The vulnerability database and/or a function of network management 150 may be to cross-index the information with the machine characteristics sent by the machines currently on the network. A list of vulnerable machines and level of the threat can be determined and used to isolate these machines in VLANX 110.

FIG. 2 represents an embodiment of a client having a manageability engine and network interface filter. Client 200 may represent a system/device/machine that is part of a partitioned network. Client 200 may represent a mobile or a stationary node on the network. Client 200 includes an operating platform 210, which represents hardware and/or software to perform operations of client 200. Platform 210 may include various hardware modules, subsystems, and/or circuits, as well as various software modules, applications, subroutines, etc. Platform 210 includes an operating system or equivalent, and may include a motherboard/main circuit board, or equivalent. Platform 210 may include a BIOS. Platform 210 provides the environment on which to execute user applications and/or system functions.

Platform 210 may provide instructions and/or perform operations that access and/or control components of a graphics and memory controller hub (GMCH) 220 or equivalent. GMCH 220 may represent hardware, software, firmware or some combination of these. These may be embodied in discrete components as well as included in chipsets. In one embodiment GMCH 220 includes manageability engine (ME) 221, which represents hardware, firmware and/or a combination and/or functions of hardware/firmware on components of GMCH 220. Manageability engine 221 may include security functions/agents to perform security monitoring and/or updating on platform 210. Manageability engine 221 may include a secure memory to store information relating to a security function. For example, manageability engine 221 may generate/obtain a configuration state that is stored in a secure storage inaccessible to components of client 200, except properly authorized/authenticated components.

Client 200 may also include an interface controller hub (ICH) 230 or equivalent. ICH 230 may include input/output (I/O) controllers and/or interfaces. Platform 210 may provide instructions, data, and or control to ICH 230 and/or perform operations that access/control components of ICH 230. ICH 230 may include a network interface 232. Network interface 232 may include a network interface card, a network interface circuit built onto a computing platform, a wireless or wireline communication transceiver, etc. Network interface 232 may support multiple mechanisms that provide interface to the network, including multiple ports, various protocols (e.g., Internet protocol (IP), Internet control message protocol (ICMP), transmission control protocol (TCP), user datagram protocol (UDP), simple network management protocol (SNMP), Telnet, file transfer protocol (FTP), hypertext transfer protocol (HTTP), etc.), and may include various open connections. Traffic transmitted, received, and/or exchanged may be considered to go through, or pass through network interface 232 to client 200.

In one embodiment ICH 230 includes filter 231, which represents one or more components/mechanisms to provide traffic filtering/grooming/manipulation/monitoring. Filter 231 may refer to control functions and/or hardware to perform various operations on traffic to or from network interface 232 and/or may refer to the operations themselves. In one embodiment filter 231 includes various registers at a medium access and/or physical interface to provide configurable network access to client 200. Filter 231 may be inaccessible directly by platform 210, rendering filter 231 secure and agnostic to the configuration and/or state of platform 210. In one embodiment network interface 232 includes a secure OOB link to provide a state setting for filter 231. Through setting filter 231, a network manager can, for example, assign a VLAN access that is applied at filter 231, potentially independently of platform 210, to direct client 200 to access the network through an assigned VLAN (e.g., NOT-OK corral, OK-corral).

Connection parameter 240 represents access to one of various possible connections: VLAN 242, VLAN 243, and console 241. In one embodiment connection parameter 240 may be understood as a connection decision resulting from the settings of filter 231, rather than as a separate physical entity. Connection parameter represents that a connection may be made at the lower layers of client 200, based on settings indicated by an administrator. Console 241 may represent a management node, for example, a vulnerability database and/or checker. VLANs 242-243 may represent one or more VLANs into which the network is partitioned, to which client 200 may be assigned. The may include various levels of potential vulnerability and associated monitoring.

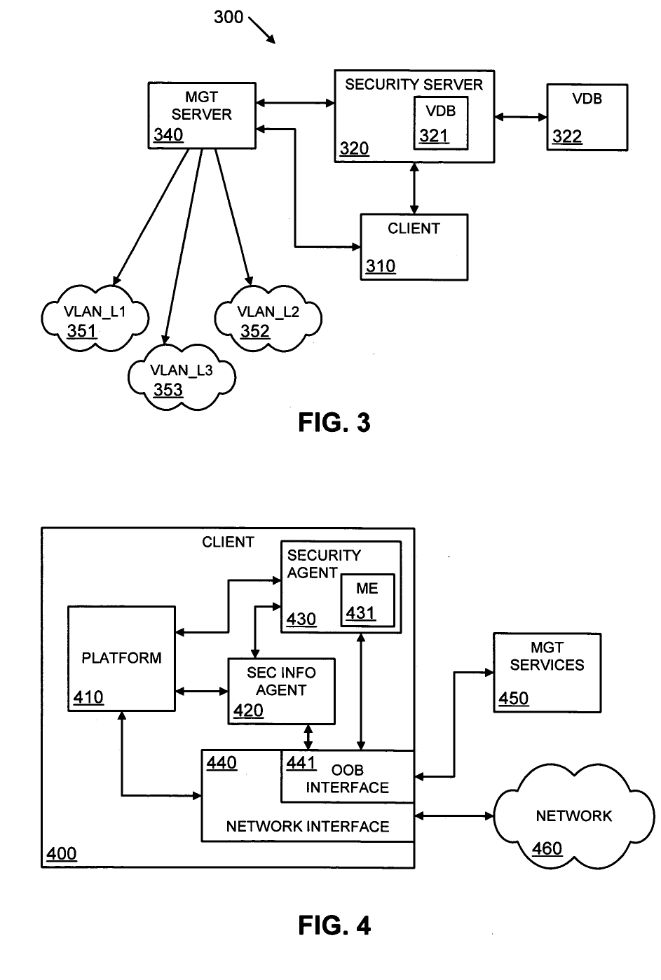

FIG. 3 represents an embodiment of network management elements in a network. Network 300 may include various management entities and/or functions. Security server 320, vulnerability databases 321 and 322, and management server 340 may exist as separate entities/functions, or may represent functions of a single entity. Client 310 represents a node accessing network 300. In one embodiment management server 340 partitions network 300 into various subnets, VLAN_L1 351, VLAN_L2 352, and VLAN_L3 353. Management server 340 may also represent a triage server, as described herein. Each VLAN may represent a subnet with differing levels of security. For example, VLAN_L1 351 may represent a subnet with general access for client 310, if client 310 is determined to be a low risk, or not considered to be a potential vulnerability threat. VLAN_L2 352 may represent an intermediate level of access, with some level of IDS if client 310 is considered to be a moderate or low potential vulnerability threat. VLAN_L3 353 may represent a remedial level of access, with a high level of security, IDS, and/or isolation from network 300, for example if client 310 is considered to be a high vulnerability threat and/or if client 310 is a guest node.

Verification and/or determination of the security of client 310 may occur through security server 320, which may represent a minimum security specification (MSS) server. In one embodiment client 310 includes an OOB communication channel with security server 320 and/or management server 340, one or both of which may in one embodiment obtain information regarding the configuration/platform state of client 310. If management server 340 receives the information, it may notify security server 320 of the potential vulnerability of client 310, for example, through a list of potentially vulnerable machines in network 300. Security server 320 may cross index/check a state of client 310 against a vulnerability database 321 located internal to security server 320 and/or a vulnerability database 322 located externally from security server 320, to which security server 320 has access. Vulnerability databases 321 and 322 may be implemented as data stored on a non-volatile storage medium (e.g., harddrive, Flash, etc.).

Management server 340 and security server 320 may be implemented with firmware, software, or a combination of firmware and software, or in hardware and/or a combination of hardware and software and/or firmware. The software and/or firmware content may provide instructions to cause executing hardware to perform various operations, including some or all of the functions/features described above. Instructions to cause a machine/electronic device/hardware to perform the operations may be received via an article of manufacture. An article of manufacture may include a machine accessible medium having content to provide the instructions, including a machine preloaded/preconfigured with software, and/or content available for access to download via a propagated carrier wave/signal. A machine accessible medium includes any mechanism that provides (i.e., stores and/or transmits) information in a form accessible by a machine (e.g., computing device, electronic device, electronic system/subsystem, etc.). For example, a machine accessible medium includes recordable/non-recordable media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.), etc.

FIG. 4 represents an embodiment of a client having a security agent and an out-of-band interface to a network management node. Client 400 represents a client of a network. The network may be a partitioned network, as described herein. Client 400 includes a platform 410 on which user operations/functions of client 400 may be executed. The platform may include the environment in which an OS and applications are run. Platform 410 may be considered to be in various states, depending upon a number of security factors. For example, the state/configuration of platform 410 may include whether security software is operational (e.g., antivirus software, firewall), whether known updates/security patches for an OS and/or an application are installed, whether the platform has connected to a network outside its home network, whether software has been added and/or modified, what the state of a BIOS of the platform is, etc. This information may be obtained by and/or stored in secure information agent 420.

Secure information agent 420 may include a secure memory, for example a Trusted Platform Module (TPM). Secure information agent 420 may include a non-volatile memory in which to store state information. The information may be determined by querying the platform and/or components of platform 410. Alternatively, platform 410 may be configured to pass the information to secure information agent 420. Secure information agent 420 may include logic, hardware, firmware, processing capabilities to perform secure storage and/or gathering functions. In one embodiment secure information agent 420 exists as a module in client 400. Alternatively, secure information agent 420 may be included as part of platform 410, assuming the security of the information may be preserved even if platform 410 were to be compromised.

Security agent 430 may operate in conjunction with secure information agent 420. In one embodiment the agents are separate entities/modules/units. Alternatively, agents 420 and 430 may be functions/parts of a single entity that acts as a double agent, providing the functions of both secure information agent 420 and security agent 430. Security agent 430 may include as a module and/or in functionality manageability engine 431. In one embodiment security agent 430 and/or secure information agent 420 represent a manageability engine of client 400. In one embodiment security information agent 420 and/or security agent 430 represent microcontroller circuits, for example on network interface 440.

Platform 410 and programs running on platform 410 may access network 460 through network interface 440. Network interface 440 may include one or more packet filters to provide traffic management. Network 460 may be partitioned as described herein. In one embodiment network interface includes OOB interface 441, which may represent a secure channel of communication. OOB interface 441 may be unavailable to platform 410, and may not be visible to platform 410. Secure information agent 420 and security agent 430 may access management services 450 through OOB interface 441. Management services 450 may include a vulnerability database cross indexer, a management server, a security server, a policy server, etc. In one embodiment management services 450 include multiple network nodes. In one embodiment management services 450 is within network 460. Management services 450 may be responsible for partitioning and maintaining network 460.

Client 400 may be a mobile node that leaves network 460 and later returns. Secure information agent 420 may store this information. In one embodiment security agent 430 determines that client 400 has left from secure information agent 420 and informs management services 450. Security agent 430 may then, either by configuration or by command from management services 450, prevent all traffic from client 400. Alternatively, security agent 430 may configure client 400 with a remedial VLAN ID, and access network 460 through a NOT-OK corral.

In one embodiment agents 420 and 430 are implemented with firmware, software, or a combination of firmware and software. Agents 420 and 430 may be implemented in hardware and/or a combination of hardware and software and/or firmware. The software and/or firmware content may provide instructions to cause executing hardware to perform various operations, including some or all of the functions/features described above. Instructions to cause a machine/electronic device/hardware to perform the operations may be received via an article of manufacture. An article of manufacture may include a machine accessible medium having content to provide the instructions. A machine accessible medium includes any mechanism that provides (i.e., stores and/or transmits) information in a form accessible by a machine (e.g., computing device, electronic device, electronic system/subsystem, etc.). For example, a machine accessible medium includes recordable/non-recordable media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.), etc.

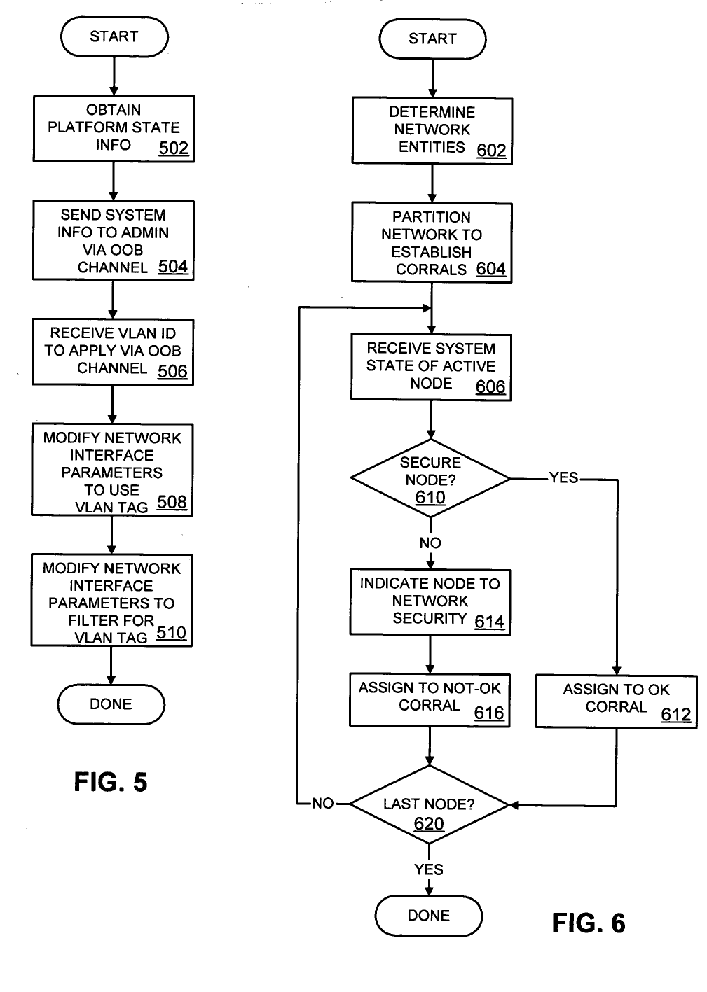

FIG. 5 represents an embodiment of a flow diagram of a network client accessing a securely segmented network. A state/condition/configuration of the platform is determined/obtained, 502. For example, a security agent/manageability engine could obtain the information. This may be monitored continuously or queried. Querying may include periodic as well as random querying. The state information may be sent to an administrator via an OOB communication channel, 504. The OOB channel may provide a secure mechanism of communication between the system/client and the network management. Secure communication could provide a mechanism to provide updates and/or critical information exchange with low risk of intrusion on the channel.

The client may receive a VLAN ID to apply, 506. This assignment may be received via the OOB channel. The VLAN ID may include an assignment to an OK corral VLAN, or a VLAN with increased security to isolate the VLAN. Applying the VLAN ID may involve setting filter parameters in a network interface filter. Thus, the client may modify network interface parameters to use the VLAN tag, 508. The client may also modify network interface parameters to filter for the VLAN tag, 510. These modifications may include the settings of hardware registers in the network interface.

FIG. 6 represents an embodiment of a flow diagram of a network management node assigning network access based on security of a node. The management node may determine what network entities/nodes exist in the network, 602. This may include receiving a set of active platforms in the network from a DHCP server. The network is partitioned to establish traffic corrals, 604. The traffic corrals may include an OK corral and a NOT-OK corral, and/or more corrals for varying levels of security. The management node may determine VLAN IDs to apply for the various corrals generated. The corrals may exist as subnets or VLANs through which traffic from certain clients is directed. Determining what clients to associate with which corrals may include determining a vulnerability level of a client.

The management node in one embodiment receives the system state of an active node, 606. This may include a configuration of the platform of the node and/or other information to indicate whether the node is compliant with a security policy. If the node is secure, 610, the node may be assigned to an OK corral VLAN as partitioned in the network, 612. If the node is determined not secure, the node may be indicated to a network security node, 614. This may include the management node generating a list of nodes determined not secure. The node may then be assigned to a NOT-OK corral VLAN, 616, and have its traffic monitored with intrusion detection/tolerant systems and/or have its network access restricted. If there are more active nodes in the network that have not received an access assignment, the management node may receive the system information of the next node, and proceed with the process for each node to be considered.

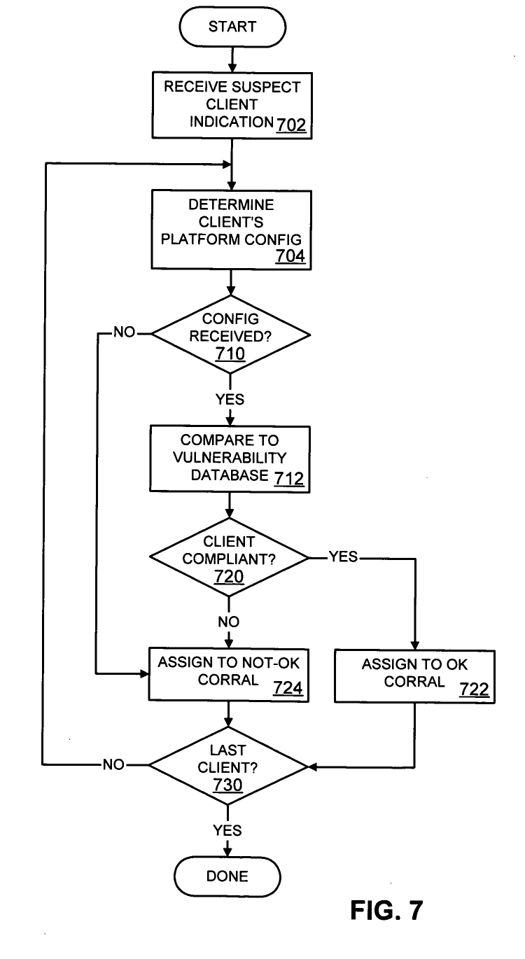

FIG. 7 represents an embodiment of a flow diagram of a network management node assigning network access based on security compliance. The management node may be a security node, having a vulnerability database against which to check clients for security compliance. The security node may receive a suspect client indication, 702. This may include a list of nodes/clients determined to not have proper platform configuration to receive an assignment to the OK corral. Thus, the suspect client indication may be received from another management node/function. In one embodiment the security node may make a similar determination, for example, as part of a routine checking of nodes on the network for compliance.

The client's platform configuration may be received directly from the client at the security node via a secure connection, e.g., an OOB channel, 704. The configuration may be received in response to a query by the security node. If the client is owned by the enterprise, it may be configured with the OOB channel interface and respond with the necessary information. If the client is not owned by the enterprise, or is corrupted, it may not be able to respond. Thus, it is determined if the configuration is received for the client, 710. If no configuration is received, the client may be determined to be a potentially vulnerable machine or is a guest (and thus potentially not secure), and is assigned to the NOT-OK corral, at least until the client can be made compliant, 724. If the configuration is received, the configuration is compared to a vulnerability database, 712. If the client is compliant with the specified state in the vulnerability database, the client is assigned to the OK corral VLAN. If the client is not compliant, it may be assigned to a remedial VLAN, 724. If there are more nodes in a suspect client list, and/or if there are more nodes to verify on the network, the security node may determine the next client's configuration and proceed in a similar manner.

Besides what is described herein, it will be appreciated that various modifications may be made to embodiments of the invention without departing from their scope. Therefore, the illustrations and examples herein should be construed in an illustrative, and not a restrictive sense. The scope of the invention should be measured solely by reference to the claims that follow.

What is claimed is:

1. A method for managing a network, comprising:
partitioning a network into a low-risk subnet and a remedial subnet, the remedial subnet isolated from and having greater security than the low-risk subnet, a client to be assigned to either the low-risk subnet or the remedial subnet;
requesting configuration information from a client of the network, the configuration information including a state of an operating platform of the client; and
determining based, at least in part, on a response of the client to the configuration information request to assign the client to the low-risk subnet if the client platform is determined to comply with a security policy, or otherwise to the remedial subnet, the client to direct network traffic through the assigned subnet.

2. A method according to claim 1, wherein the subnets have associated subnet identifiers, and wherein determining to assign the client to a subnet comprises assigning a subnet identifier to which the client will transmit network traffic to be routed.

3. A method according to claim 2, wherein partitioning the network further comprises determining the identifiers to associate with the subnets.

4. A method according to claim 2, wherein the subnet identifiers comprise virtual local area network (VLAN) identifiers (IDs), and wherein determining to assign the client to a subnet comprises assigning a VLAN tag to indicate the VLAN ID of the assigned subnet.

5. A method according to claim 1, wherein the remedial subnet includes an intrusion detection system (IDS) through which network traffic from the client is directed.

6. A method according to claim 1, wherein requesting the configuration information comprises requesting the configuration information as part of an authentication exchange.

7. A method according to claim 1, wherein requesting the configuration information comprises requesting the configuration information for verification of the client when the client has already been authenticated and has a subnet assignment.

8. A method according to claim 7, further comprising:
receiving the requested configuration information in response to the request;
determining from the configuration information if the client complies with the security policy; and
if the client is determined to have changed from complying to not complying with the security policy, or from not complying to complying with the security policy, re-assigning the client to either the remedial subnet or the low-risk subnet.

9. A method according to claim 1, further comprising assigning the client to the remedial subnet if no response from the client is received to the configuration information request.

10. A method according to claim 1, wherein requesting the configuration information comprises requesting the configuration information over an out-of-band communication link with the client.

11. An article of manufacture comprising a machine accessible medium having content to provide instructions to result in a machine performing operations including:
partitioning a network into a low-risk subnet and a remedial subnet, the subnets having associated subnet identifiers, the remedial subnet isolated from and having greater security than the low-risk subnet, a client to be assigned to either the low-risk subnet or the remedial subnet;
requesting configuration information from a client of the network, the configuration information including a state of an operating platform of the client; and
determining based, at least in part, on a response of the client to the configuration information request to indicate to the client the identifier associated with the low-risk subnet if the client platform is determined to comply with a security policy, or otherwise to indicate the identifier of the remedial subnet, the client to direct network traffic through the subnet of the indicated identifier.

12. An article of manufacture according to claim 11, wherein the subnet identifiers comprise virtual local area network (VLAN) identifiers (IDs), and wherein indicating to the client a subnet identifier comprises assigning to the client a VLAN tag of the indicated subnet.

13. An article of manufacture according to claim 11, wherein the content to provide instructions to result in the machine partitioning the network further comprises the content to provide instructions to result in the machine monitoring traffic of the remedial subnet and not monitoring traffic of the low-risk subnet.

14. An article of manufacture according to claim 11, further comprising the content to provide instructions to result in the machine performing operations including:
receiving the requested configuration information in response to the request;
determining from the configuration information if the client complies with the security policy; and
if the client is determined to have changed from complying to not complying with the security policy, or from not complying to complying with the security policy, re-assigning the client to either the remedial subnet or the low-risk subnet.

15. An article of manufacture according to claim 11, wherein the content to provide instructions to result in the machine requesting the configuration information comprises the content to provide instructions to result in the machine requesting the configuration information over an out-of-band communication link with the client.

16. A network manager, comprising:
a network node to determine a virtual local areas network identifier (VLAN ID) to assign to an isolation subnet of a network, receive information from a network machine to indicate a configuration of the machine, and direct the machine to filter network traffic with the VLAN ID to direct traffic from the machine through the isolation subnet, if the machine fails to comply with a minimum security specification for the network, the isolation subnet to monitor packets passing through the isolation subnet for attack traffic; and
a database coupled with the network node to store the minimum security specification, the database to be queried by the network node to determine if the machine complies with the minimum security specification.

17. A network manager according to claim 16, the network node further to maintain a secure out-of-band communication link with the machine.

18. A network manager according to claim 16, wherein the network node comprises a subnet server to partition the network into multiple VLANs, each VLAN having an associated VLAN ID, and to provide a VLAN ID to the machine, and a security specification server to determine compliance of the machine with the minimum security specification.

19. A network manager according to claim 16, the network node further to provide updates for the machine to install to bring the machine into compliance with the minimum security specification.

20. A network manager according to claim 19, the network node further to direct the machine to change network access and apply a VLAN ID of a immunized-machine subnet if the machine is made to comply with the minimum security specification.

21. A method for participating in a network, comprising:
determining a state of an operating platform;
sending information regarding the state to a management node of a network for verification of compliance with a minimum security specification;
receiving from the management node a network access assignment in response to the sending the information, the access assignment indicating a quarantine subnet if the state of the platform fails verification; and
transmitting and receiving network traffic through the quarantine subnet.

22. A method according to claim 21, wherein determining the state of the operating platform comprises determining what upgrades are installed on the platform.

23. A method according to claim 21, wherein determining the state of the operating platform comprises determining what patches are installed on the platform.

24. A method according to claim 23, wherein determining what patches are installed comprises determining what patches are installed on an application running on the platform.

25. A method according to claim 23, wherein determining what patches are installed comprises determining what patches are installed on an operating system running on the platform.

26. A method according to claim 21, wherein sending the information comprises sending the information over an out-of-band communication link.

27. A method according to claim 21, further comprising:
receiving from the management node an access assignment indicating a default access subnet if the state of the platform passes verification;
wherein sending the information regarding the state comprises sending the information as part of a periodic verification process; and
wherein receiving from the management node the network access assignment indicating the quarantine subnet comprises changing the access assignment from the default access subnet to the quarantine subnet in response to a verification failure in the periodic verification process.

28. A method according to claim 21, further comprising:
receiving from the management node an access assignment indicating a default access subnet if the state of the platform passes verification;
leaving the network and accessing a different network;
returning to the network and sending the information regarding the state to the management node, the information including an indication that the different network was accessed; and
receiving from the management node a network access assignment indicating the quarantine subnet in response to receiving the indication that the different network was accessed.

29. A method according to claim 28, further comprising:
modifying the state of the operating platform to comply with the minimum security specification; and
receiving from the management node the access assignment indicating the default access subnet in response to complying with the minimum security specification.

30. An article of manufacture comprising a machine accessible medium having content to provide instructions to result in a machine performing operations including:
determining a configuration of an operating platform, including a state of updates installed on the operating platform;
sending information regarding the state to a management node of a network for verification of compliance with a minimum security specification;
receiving from the management node a network access assignment in response to the sending the information, the access assignment indicating a quarantine subnet if the state of the platform fails verification; and
transmitting and receiving network traffic through the quarantine subnet.

31. An article of manufacture according to claim 30, wherein the content to provide instructions to result in the machine sending the information comprises the content to provide instructions to result in the machine sending the information over an out-of-band communication link.

32. An article of manufacture according to claim 30, further comprising the content to provide instructions to result in the machine performing operations including:
receiving from the management node an access assignment indicating a general-access subnet if the state of the platform passes verification;
wherein sending the information regarding the state comprises sending the information as part of a verification interchange; and
wherein receiving from the management node the network access assignment indicating the quarantine subnet comprises changing the access assignment from the default access subnet to the quarantine subnet in response to a verification failure for non-compliance to a network security policy or for accessing a different network of unknown security.

33. An article of manufacture according to claim 32, further comprising the content to provide instructions to result in the machine performing operations including:
modifying the configuration of the operating platform to comply with the network security policy; and
receiving from the management node the access assignment indicating the default access subnet in response to complying with the minimum security specification.

34. A network client device, comprising:
an operating platform to execute an operating system and a user application;
a security agent coupled with the operating platform to determine a state of the operating platform and transmit the state to a security server node over a secure communication channel and receive an access assignment for one of multiple subnets in a network, the access assignment based, at least in part, on the state of the operating platform; and
a network interface coupled with the security agent having a packet filter to be configured according to the access assignment as indicated by the security agent to the network interface.

35. A network client according to claim 34, the security agent to obtain information from the operating platform to determine compliance of the operating platform to a minimum security specification.

36. A network client according to claim 34, wherein the packet filter comprises a configurable register on a network access circuit.

37. A network client according to claim 34, wherein the security agent comprises a microcontroller circuit on the client device.

38. A network client according to claim 34, wherein the access assignment comprises an assignment to a high-security remedial virtual local area network (VLAN), the high security including packet monitoring by an intrusion detection system (IDS).

39. A network system comprising:
a management node to partition a network into multiple virtual local area networks (VLANs) of differing levels of traffic security monitoring;
a security node communicatively coupled with the management node, to receive state information for a client in the network, determine a level of vulnerability of the client based, at least in part, on a compliance to a security configuration indicated in the state information, and assign the client to one of the VLANs based, at least in part, on the level of vulnerability, an increasing strictness of the level of traffic security monitoring in the VLANs corresponding to an increasing level of vulnerability of the client; and
a non-volatile memory coupled with the security node to store a vulnerability database of security configuration parameters to determine the level of vulnerability of the client.

40. A system according to claim 39, the security node and the management node to maintain an out-of-band communication link with the client.

41. A system according to claim 39, the security node to assign the client to a VLAN of minimal security if the client is determined to have total compliance with the security configuration parameters of the vulnerability database, and to a VLAN of higher security if the client is determined to be non-compliant with the security configuration parameters.
